(19) United States
(12) Patent Application Publication
(10) Pub. No.: US 2011/0271804 A1
(43) Pub. Date: Nov. 10, 2011

(54) CENTRE DRILLING/TURNING TOOL HOLDER

(76) Inventor: Chun-Ta Hsieh, Taichung City (TW)

(21) Appl. No.: 12/773,019

(22) Filed: May 4, 2010

(51) Int. Cl. B23B 29/12

(52) U.S. Cl. 82/158

(57) ABSTRACT

The invention discloses a centre drilling/turning tool holder including a stock receiver, a pillar holder, and a tail section. The stock receiver is used to position a workpiece. The pillar holder is able to move and spin, and has a plurality of positioning means for positioning a tool. The tail section is able to move and has a top pin for urging the workpiece. The pillar holder positions at least one tool holder. One side of the tool holder positions one tool. The configuration of the tool holder allows the pillar holder to avoid from contacting the tail section so that operation time is saved and centre-point correction becomes more efficient.

### BACKGROUND OF THE INVENTION

1. Field of the Invention

The present invention relates to lathe field. More specifically, it relates to a centre drilling/turning tool holder which saves operation time of a pillar holder and reduces the number of centre-point correction, bringing efficiency and preventing error in correction when in use.

2. Related Prior Art

FIG. 1 through FIG. 4 shows the operation of processing a workpiece by a lathe. A stock receiver 1 clips a workpiece 2. A pillar holder 3 moves to allow a drill head 4 of the pillar holder 3 aligns with centre of the worpiece 2 and then drills the workpiece 2 until a recession is formed on the workpiece 2. After the pillar holder 3 withdraws back, the workpiece 2 moves into a tail section 5. A top pin 6 of the tail section 5 urges against the recession of the workpiece 2 to further position the workpiece 2. In turns, the workpiece 2 moves to the pillar holder 3 so that the tool of the pillar holder 3 can contact the workpiece 2 to cut the workpiece 2. This process needs multiple times of centre-point correction which takes time and may generate correction errors.

When the drill head 4 finishes the drill operation, a column clipper 7 on the pillar holder 3, which is used to position the drill head, is large in volume and length, therefore the pillar holder 3 needs to withdraw a great distance from the drill head 4 so that the column clipper 7 can avoid from contacting the tail section 5. It takes time to perform such a withdrawing process.

Similarly, the pillar holder 3 needs to move back an equal distance and runs a correction once more. Whenever a workpiece is drilled, it needs to move away and back the pillar holder, adding time cost and correction errors.

Some efforts have been made to solve such problems by cutting. For example, a slot is formed on the column clipper 7 of the pillar holder 3 to avoid the tail section 5. This approach disadvantageously damages the column clipper 7.

Another approach adds on the pillar holder 3 a plurality of tool holders with positioning holes. Those positioning holes are used to position drill heads of various specifications or sizes. When the drill head of different size or specification is used, it needs to perform the correction.

Therefore, there is a need of novel centre drilling/turning tool holder which overcomes the above shortages.

### SUMMARY OF THE INVENTION

One object of the invention is to provide a centre drilling/turning tool holder which saves operation time of a pillar holder and reduces the number of centre-point correction, bringing efficiency and preventing error in correction when in use.

Another object of the invention is to provide a centre drilling/turning tool holder which has no need to separate any positioning means inherently used in pillar holder of the original lathe.

Still another object of the invention is to provide a tool holder which can hold tools or drill heads of various sizes, using the same center.

Still another object of the invention is to provide a tuning means which can tunes the location of the tool holder.

In order to achieve the above and other objectives, the centre drilling/turning tool holder according to the invention includes a stock receiver, used to position a workpiece;
a pillar holder, able to move and spin, having a plurality of positioning means for positioning a tool;
a tail section, able to move, and having a top pin for urging the workpiece;
wherein the pillar holder positions at least one tool holder, one side of the tool holder positions one tool, the configuration of the tool holder allows the pillar holder to avoid from contacting the tail section so that operation time is saved and centre-point correction becomes more efficient.

Other objectives, advantages and features of the present invention will become apparent from the following description referring to the attached drawings.

### BRIEF DESCRIPTION OF THE DRAWINGS

The present invention will be described via detailed illustration of the preferred embodiment versus prior art referring to the drawings where:

FIG. 1 is a schematic plan view of a conventional stock receiver, pillar holder and tail section.

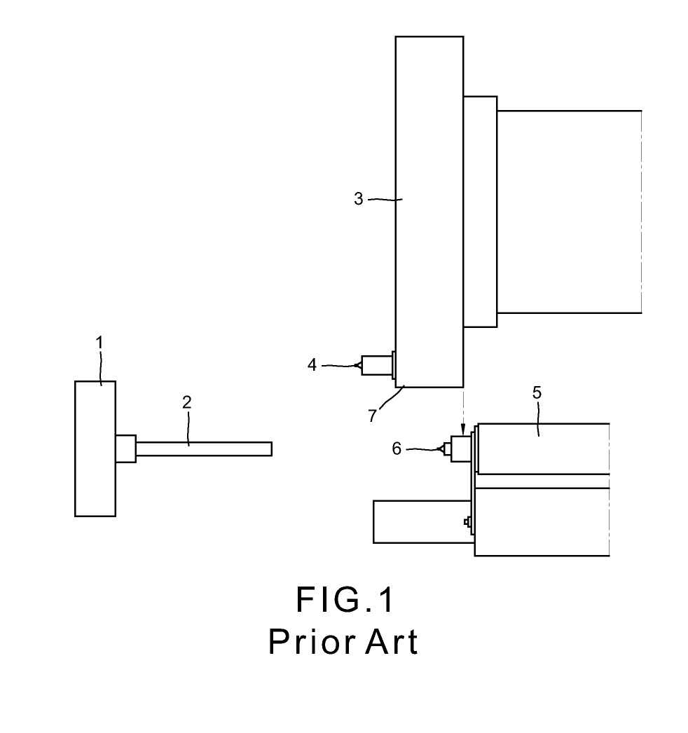

FIG. 2 is a schematic side view of a conventional pillar holder and tail section.

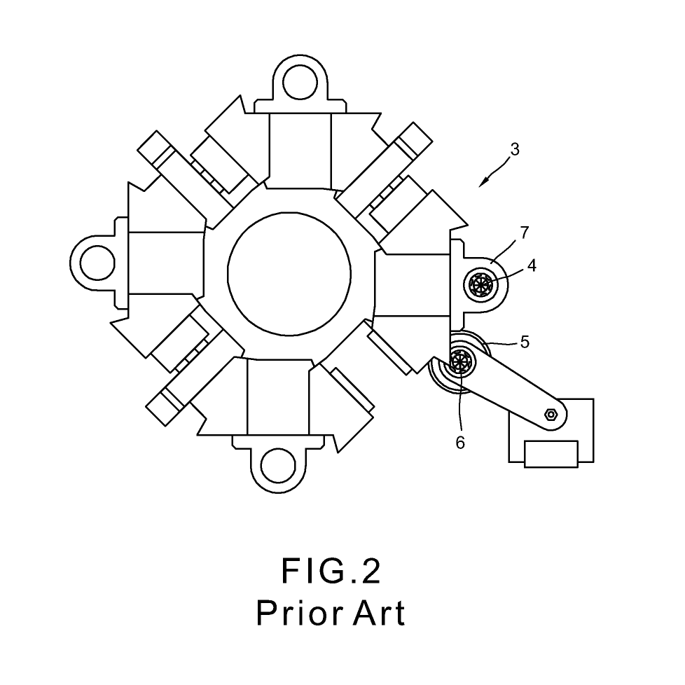

FIG. 3 is a schematic plan view showing the drilling operation of a workpiece in the art.

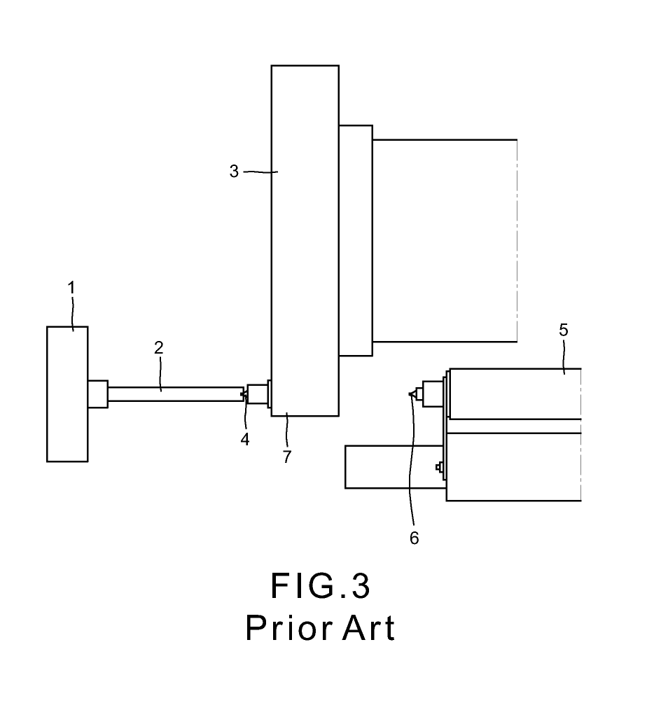

FIG. 4 is a schematic plan view showing a workpiece to be cut in the art.

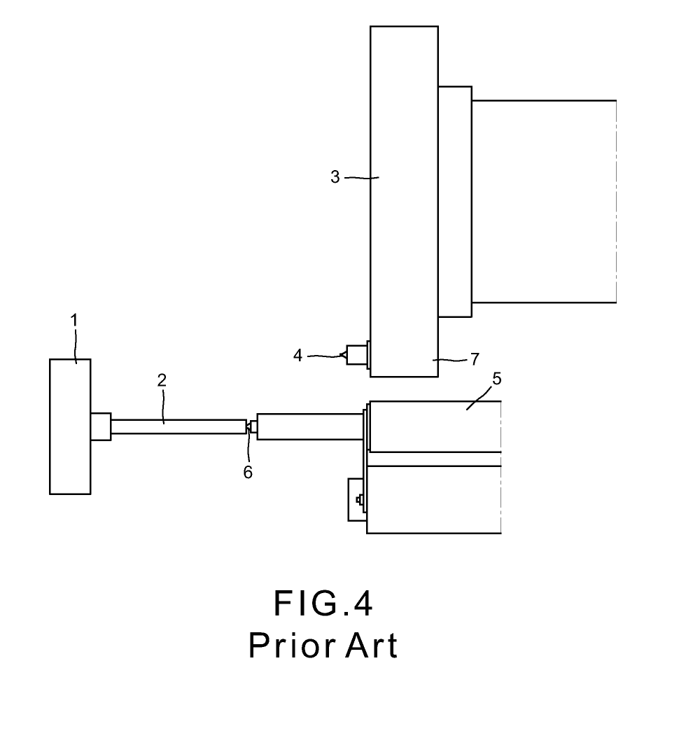

FIG. 5 is a schematic plan view of a stock receiver, a pillar holder and a tail section according to a first embodiment of the invention.

FIG. 6 is perspective view of a tool holder according to a first embodiment of the invention.

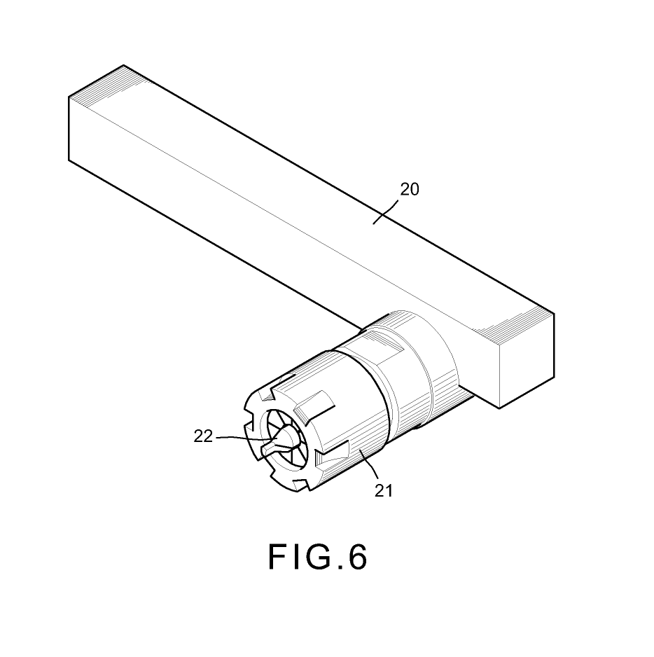

FIG. 7 is a schematic side view of a pillar holder and a tail section according to a first embodiment of the invention.

FIG. 8 is a schematic plan view showing the drilling operation of a workpiece according to a first embodiment of the invention.

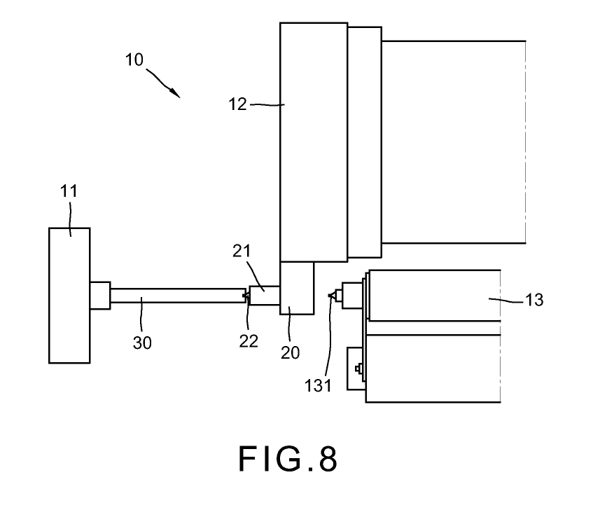

FIG. 9 is a schematic plan view showing a workpiece to be cut according to a first embodiment of the invention.

FIG. 10 is a perspective exploded view of a tuning means of a tool holder according to a second embodiment of the invention.

FIG. 11 is a perspective view of a tuning means of a tool holder according to a second embodiment of the invention.

### DETAILED DESCRIPTION OF THE INVENTION

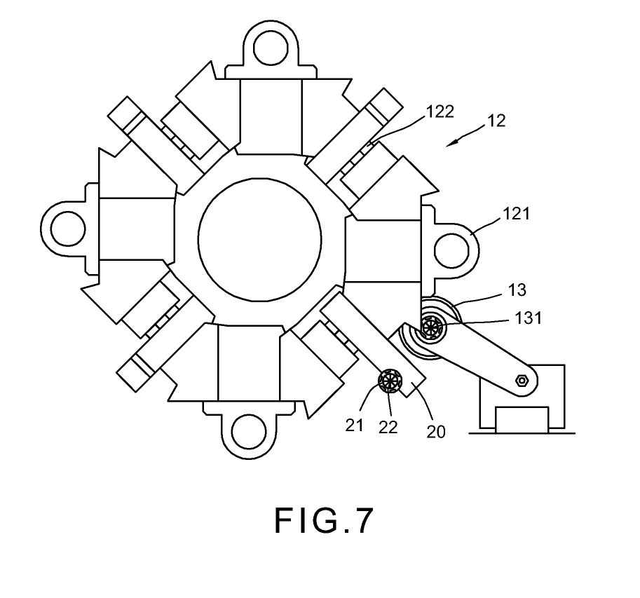

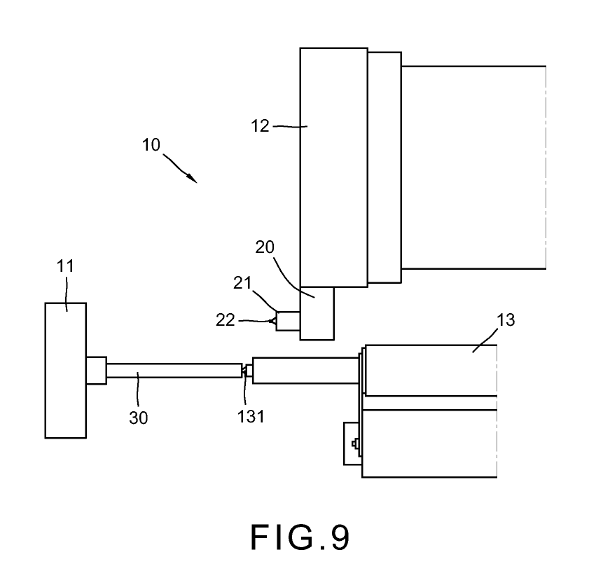

As shown in 5 through FIG. 9, a centre drilling/turning tool holder of the invention has a plurality of tool holders 20 on a lathe 10 which mainly include a stock receiver 11, a pillar holder 12 and a tail section 13. The stock receiver 11 is a movable receiver to position a workpiece 30. Opposite to the stock receiver 11 is the tail section 13 which is also movable and has a top pin 131 at its front for urging the workpiece 30 against the stock receiver 11. The pillar holder 12 locates inside the stock receiver 11 and the tail section 13 in a manner of being able to spin and move. A plurality of positioning means surrounds the pillar holder 12 in order to position the tools or drill heads which are used to cut or drill the workpieces 30. The positioning means on the pillar holder 12 has a plurality of column clippers 121 and a plurality of clamping slots 122, as shown in FIG. 7.

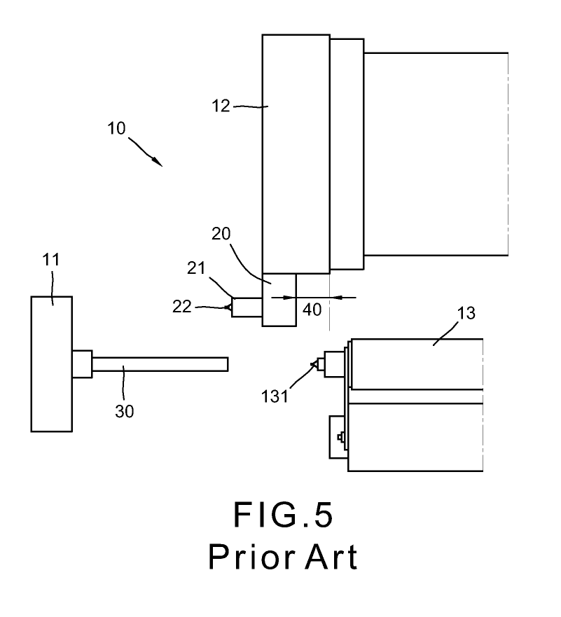

In the invention, at least one tool holder 20 is positioned on the pillar holder 12. The tool holder 20 locates in the clamping slot 122. The tool holder 20 is an arm of rectangular shape, having thickness less than the length of the column clipper 121. The tool holder 20 further provides a space 40, as shown in FIG. 5, for the pillar holder 12 to freely spin without hitting the top pin 131 of the tail section 12. One side of the tool holder 20 has an elastic clipper 21 to position tools 22 of various sizes. Any one of the tools 22 can be a drill head, inner-hole cutter or tapping tool. Those tools 22 of various sizes can be operated around the same center.

In a first embodiment of the invention, the workpiece 30 is first placed into the stock receiver 11 so that the workpiece 30 can be held by the stock receiver 11. Then the pillar holder 12 moves and spins so that the tools 22 on the tool holder 20 align with the centre of the workpiece 30. After one side of the workpiece 30 is drilled to form a recession, the pillar holder 12 withdraws back. The workpiece 30 further moves into the tail section 13. The top pin 131 of the tail section 13 urges against the recession of the workpiece 30 for further fixing the workpiece 30. Then the pillar holder 12 moves to allow the tools on the pillar holder 12 to cut the workpiece 30.

Since the tool holder 20 has a thickness less than the length of the column clipper 121, the space 40 is enough for the pillar holder 12 to spin without contacting the tail section 13, saving time needed for disassembly or centre-point correction of the workpiece 30, and also preventing errors happened in centre-point correction.

The elastic clipper 21 of the tool holder 20 can be used to position the tools 22 of various sizes, using the same centre. Therefore only one elastic clipper 21 is needed, which brings great efficiency and convenience in use.

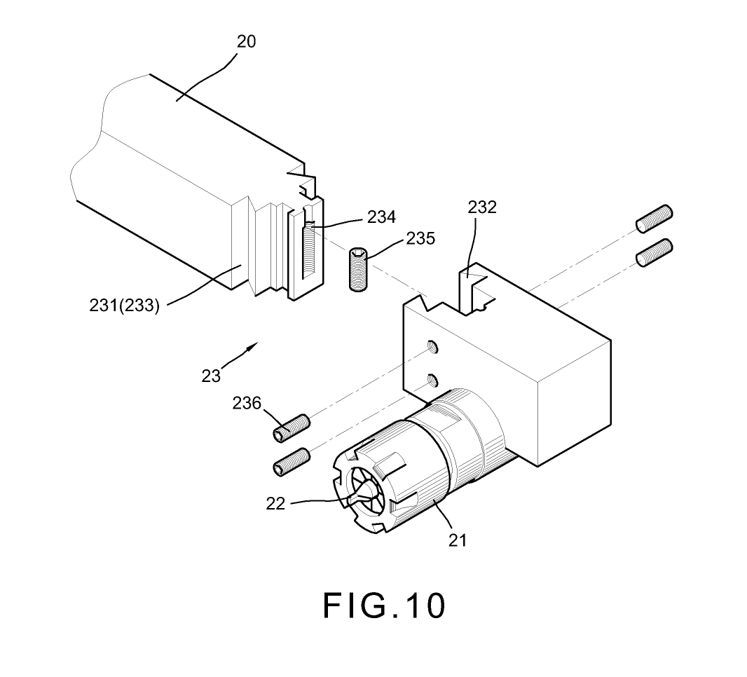

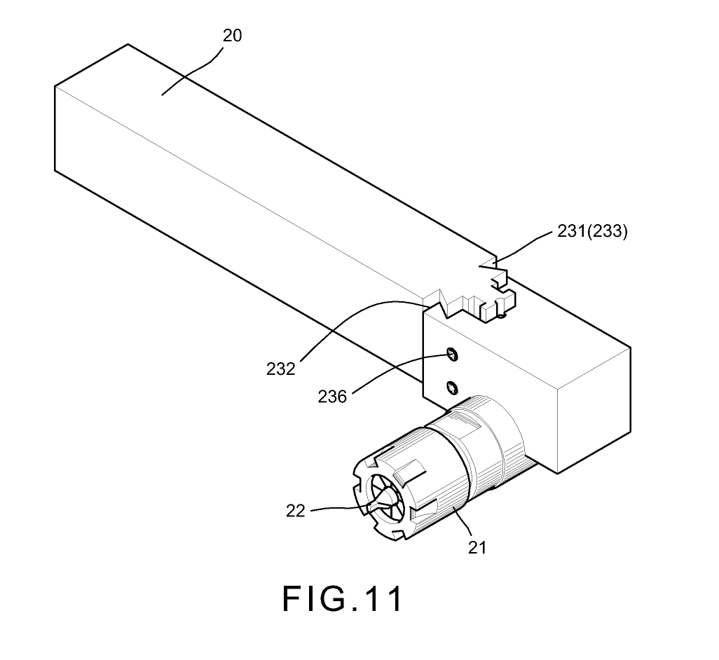

In a second embodiment of the invention, as shown in FIGS. 10 and 11, the entire configuration is the same as the first embodiment, except that a tuning means 23 is added on the tool holder 20. The tool holder 20 has two cross sections 231, 232 which are positioned by a dovetail groove 233 in a manner that the two cross sections 231, 232 can swap. The dovetail groove 233 has a threaded hole 234 near its centre, vertically along the cross sections 231, 232. The dovetail groove 233 further has an adjusting stud 235 therein for tuning the cross sections 231, 232 to swap. At each side of the dovetail groove 232 is mounted a stopping stud 236 horizontally along the cross sections 231, 232 to fix the cross sections 231, 232.

In adjusting, the two stopping studs 236 at both sides are loosen, and then the adjusting stud 235 is rotated to swap the cross sections 231, 232 so that the tool holder 20 moves up or down. Thereby, the centre-point correction is achieved.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A centre drilling/turning tool holder, comprising:
a stock receiver, used to position a workpiece;
a pillar holder, able to move and spin, having a plurality of positioning means for positioning a tool;
a tail section, able to move, and having a top pin for urging the workpiece;
wherein the pillar holder positions at least one tool holder, one side of the tool holder positions one tool, the configuration of the tool holder allows the pillar holder to avoid from contacting the tail section so that operation time is saved and centre-point correction becomes more efficient.

2. The centre drilling/turning tool holder of claim 1, wherein the tool holder is an arm, having an elastic clipper at one side thereof for positioning the tool.

3. The centre drilling/turning tool holder of claim 1, wherein a space is defined at one side of the tool holder for the tail section to pass.

4. The centre drilling/turning tool holder of claim 1, wherein the tool holder has a tuning means which has two cross sections positioned by a dovetail groove so that the two cross sections can swap.

5. The centre drilling/turning tool holder of claim 4, wherein the dovetail groove has a threaded hole near its centre, and has an adjusting stud therein.

6. The centre drilling/turning tool holder of claim 4, wherein each side of the dovetail groove has at least one stopping stud.
